(19) United States
(12) Patent Application Publication
(10) Pub. No.: US 2024/0082851 A1
(43) Pub. Date: Mar. 14, 2024

(54) IMPACT REACTOR

(71) Applicant: SCHÄFER ELEKTROTECHNIK U. SONDERMASCHINEN GMBH, Rüssingen (DE)

(72) Inventor: Ralf SCHÄFER, Rüssingen (DE)

(21) Appl. No.: 18/263,182

(22) PCT Filed: Feb. 16, 2022
(86) PCT No.: PCT/EP2022/053815

§ 371 Date: Jul. 27, 2023

(30) Foreign Application Priority Data
Feb. 17, 2021 (DE) 10 2021 103 764.6

(51) Int. Cl. B02C 13/284; B02C 13/14; B02C 23/16

(52) U.S. Cl. CPC B02C 13/284; B02C 13/14; B02C 23/16; B02C 2023/165

(57) ABSTRACT

An impact reactor for comminuting material to be comminuted, comprising a cylindrical casing, a bottom, wherein the casing, the bottom and the cover enclose an impact reactor chamber, wherein a rotor is arranged in the impact reactor chamber, wherein the rotor is provided with impact elements, wherein at least one feed opening is provided for feeding material to be comminuted into the impact reactor chamber, and wherein at least one removal opening is provided for removing comminuted material and/or gaseous comminuted products from the impact reactor chamber, wherein the feed opening and/or the removal opening are closable.

The invention relates to an impact reactor for comminuting of material to be comminuted, comprising a cylindrical casing, a bottom and a cover, wherein the casing, the bottom and the cover enclose an impact reactor chamber, wherein a rotor is arranged in the impact reactor chamber, wherein the rotor is provided with impact elements, wherein at least one feed opening for feeding material to be comminuted is provided in the impact reactor chamber, and wherein at least one removal opening for removing comminuted material from the impact reactor chamber is provided.

Impact reactors are used to comminute material to be comminuted, which can be composed of different materials, in such a way that material separation and subsequent recycling is possible. In this process, the material to be comminuted is comminuted by impact stress with a high momentum transfer by means of rotating impact elements and separated into individual components. Such an impact reactor is known, for example, from WO 2018/037053 A1.

The invention is based on the task of providing an impact reactor for comminuting material to be comminuted, which enables a particularly good material separation of the comminuted material.

This task is solved with the features of claim 1. The subclaims refer to advantageous embodiments.

The impact reactor according to the invention for comminuting material to be comminuted comprises a cylindrical casing, a bottom and a cover, wherein the casing, the bottom and the cover enclose an impact reactor chamber, wherein a rotor is arranged in the impact reactor chamber, wherein the rotor is provided with impact elements, wherein at least one feed opening is provided for feeding material to be comminuted into the impact reactor chamber and wherein at least one removal opening is provided for removing comminuted material from the impact reactor chamber, wherein the feed opening and/or the removal opening is closable. This allows an atmosphere that is independent of the ambient air to be created in the impact reactor. This is particularly advantageous if chemically reactive material is to be comminuted in the impact reactor. Such materials to be comminuted are, for example, accumulators, in particular accumulators that have not yet been fully discharged or have not been inactivated by thermal pretreatment.

The rotor preferably has one or two rotor arms distributed regularly around the circumference, wherein impact elements are arranged replaceably at the free ends of the rotor arms. Preferably, the rotor has a two-winged design and has two rotor arms formed in one piece and made of the same material, which are centrally connected to a drive shaft, wherein the drive shaft is connected to an electric motor. Alternatively, the drive can also be provided by a hydraulic motor. The rotor arms can be formed rod-shaped, wing-shaped or sword-shaped. For better mechanical stability, the cross-section of the rotor arms can increase in the direction of the drive shaft.

Furthermore, it is conceivable that the rotor arms are made of chains or ropes. The impact elements are preferably flat, for example made of a plate-shaped material. The impact elements can be rectangular when viewed in the circumferential direction, but also drop-shaped or similar. The impact elements have an impact surface that points in the circumferential direction. As a result, the impact elements come into intensive contact with the material to be comminuted during the impact process. The impact elements are preferably attached to the rotor arms by means of a screw connection.

The impact elements can be rounded in the area of the peripheral edges. This is advantageous if no intensive comminution is desired, but only a momentum transfer for a separation of material combinations is required. These can be, for example, plastic housings of small electrical appliances.

A first removal opening can be disposed in the casing, wherein the first removal opening comprises a screen. Screens are classifying devices that are designed in a particularly simple manner and are particularly robust. By selecting the hole diameter, or mesh size, the particle sizes to be passed through can be defined. The screen can be of variable design, for example by means of a slide which modifies the gap width or mesh size. This allows the permeability for the comminuted products to be adjusted with regard to their size. This can also be done during ongoing operation.

A classifier can be associated with the first removal opening. Particles can be separated from a material flow by the classifier, wherein it is also possible, depending on the design of the classifier, to separate particles from the material flow as a function of size and/or mass.

The classifier can comprise a deflector wheel. A deflector wheel, also referred to as a deflector wheel classifier, is essentially formed in the shape of a radial fan. A deflector wheel is a centrifugal force air-classifier. The deflector wheel comprises a hub which can be set in rotation. Rotor disks are arranged on the hub at an axial distance from one another, wherein rotor blades are arranged on the rotor disks and distributed over the circumference, wherein the rotor blades can be formed from a sheet metal strip or from a profile. An opening is introduced centrally in a rotor disk through which air is extracted from the impact reactor chamber. The air flowing through the opening and thus also through the deflector wheel is also referred to as classifying air. Particle-laden classifying air flows from the impact reactor chamber into the deflector wheel via the outer circumference and the rotor blades of the rotor.

The rotation of the deflector wheel accelerates the classifying air in the circumferential direction and also causes it to rotate. The particles are acted upon by centrifugal force, wherein particles above the separation limit are rejected and separated from the classifying air. Accordingly, particles with a diameter above the separation limit are separated and particles with a diameter below the separation limit are allowed to pass through. The separated particles move back into the impact reactor chamber due to the centrifugal force acting on them. The particles that are allowed to pass through are extracted with the classifying air. The separation limit is essentially determined by the density of the particles, the speed of the deflector wheel, the diameter of the rotor disks, and the volumetric flow and viscosity of the classifying air. Depending on the design of the deflector wheel, the separation limit can be 0.5 μm or more.

A second removal opening can be associated with the casing, wherein a second removal flap is associated with the second removal opening. Material that cannot be removed via the first removal opening can be removed from the impact reactor chamber via the second removal flap. The material removed from the impact reactor chamber can pass through the second removal flap into an ejection box, from where it can be supplied for further recycling. In particular, it is conceivable to perform a further separation in a second classifier associated with the ejection box. The second classifier can be a gravity classifier, cyclone, or zigzag classifier. In the second classifier, material fractions can be separated according to density, for example a plastic fraction from a metal fraction.

If the second removal flap of the second removal opening is opened while the rotor is running, excess pressure can occur in the ejection box. In order to reduce the excess pressure, a second opening can be associated with the ejection box, from which gas can flow out in a targeted manner. To ensure that no particles are discharged through the second opening, a separator in the form of a deflector wheel is preferably associated with the second opening. The deflector wheel is preferably designed to allow only gaseous components and particles with a particle size of less than 0.5 μm to pass through. However, particles with a preselected larger particle size can also be discharged through the deflector wheel. In this case, particles can be discharged via the opening in a targeted manner.

A third removal opening can be associated with the impact reactor, wherein at least one deflector wheel is associated with the third removal opening. In this embodiment, the impact reactor comprises at least two removal openings, wherein a screen and/or a classifier is associated with the first removal opening and wherein a deflector wheel is associated with the third removal opening. Depending on the design of the deflector wheel, it is possible either to discharge gases released during comminution from the impact reactor chamber or to discharge particles with a preselected particle size. It is also conceivable to generate a negative pressure in the impact reactor chamber via the third removal opening, wherein the deflector wheel is equipped to allow only particles with a preselected maximum size or only gaseous components to pass through. As a result, noxious gases occurring during comminution can be removed from the impact reactor chamber in a particularly safe manner, and it is also possible to prevent the noxious gases from escaping into the environment.

According to a first advantageous embodiment, the speed of the deflector wheel associated with the third removal opening is variable. Preferably, the speed of the deflector wheel can be selected from three speed levels.

This makes it possible, for example, to provide a first speed level at which the deflector wheel only allows gaseous constituents and particles with a particle size of less than 0.5 μm to pass through. A second speed level can be provided at which particles of a certain maximum size, for example particles having a particle size of 0.5 μm to 200 μm, are allowed to pass through the deflector wheel, and a third speed level can be provided at which coarser particles suspended in the impact reactor chamber, for example particles having a particle size of 200 μm to a particle size of 500 μm, are allowed to pass through. This allows for a separation of gases and substances of different sizes to be performed during the comminution process by means of the deflector wheel.

According to an advantageous method, separation first takes place during comminution via the deflector wheel, which rotates at the first speed level and is thereby set up to allow gaseous constituents to pass through. This speed level has a particularly high speed. In this step, gaseous components of the accumulators to be comminuted, such as solvents, which are initially released during the comminution process can be extracted via the rapidly rotating deflector wheel. It is advantageous that the rapidly rotating deflector wheel deflects particles, at least particles with a particle size of more than 0.5 μm, from the air stream of the classifying air, so that they remain in the impact reactor chamber.

In a next step, the speed of the deflector wheel is reduced so that the deflector wheel rotates at the second speed level. At the second speed level, particles with a medium particle size pass through, preferably particles with a particle size of more than 0.5 μm up to a particle size of 200 μm. The second speed level is preferably used only after the gaseous components have been extracted via the first speed level. In the second speed level, in particular, the particulate black mass can be extracted from the impact reactor chamber.

In a third step, the speed of the deflector wheel is reduced again to allow coarse particles to pass through. At the third speed level, the deflector wheel is preferably set up to allow particles in the air stream with a particle size of more than 200 μm and up to a particle size of 1 mm to pass through.

According to an advantageous embodiment, a plurality of deflector wheels can be associated with the third removal opening for separating gases and/or particles of various sizes. According to a first advantageous embodiment, two deflector wheels are provided. According to another advantageous embodiment, three deflector wheels are provided.

Each of the deflector wheels associated with the third removal opening is equipped to allow particles of a preselected size to pass through. This makes it possible, for example, to provide a first deflector wheel that allows only gaseous components and particles with a particle size of less than 0.5 μm to pass through. A second deflector wheel can be provided to allow particles having a certain minimum size, for example particles having a particle size of 0.5 μm to 200 μm, to pass through, and a third deflector wheel can be provided to allow particles suspended in the impact reactor chamber, for example particles having a particle size of 200 μm to 500 μm, to pass through. As a result, by means of the arrangement of deflector wheels, separation of gases and substances of different sizes can be carried out during the comminution process.

According to an advantageous method, separation first takes place during comminution via the first deflector wheel, which is set up to allow gaseous constituents to pass through. This deflector wheel rotates at a particularly high speed. In this step, gaseous components of the accumulators to be comminuted, such as solvents, which are initially released during the comminution process can be extracted via the rapidly rotating deflector wheel. It is advantageous that particles, at least particles with a particle size of more than 0.5 μm, are separated from the air stream of the classifying air by the rapidly rotating deflector wheel and remain in the impact reactor chamber.

In a next step, separation takes place via the second deflector wheel, which is set up to allow particles with a medium particle size, preferably particles with a particle size of more than 0.5 μm up to a particle size of 200 μm, to pass through. The second deflector wheel is preferably used only after the gaseous components have been removed via the first deflector wheel. The second deflector wheel can be used in particular to remove the particulate black mass, also referred to as active mass, from the impact reactor chamber.

In a third step, coarse particles are allowed to pass through the third deflector wheel. The third deflector wheel is preferably set up to separate particles in the air stream with a particle size of more than 200 μm and up to a particle size of 1 mm. For this purpose, the third deflector wheel can rotate at a low speed compared to the second deflector wheel.

The deflector wheels are preferably operated one after the other, so that material is discharged only via one active deflector wheel at a time.

The material flows that have passed through the deflector wheels can be fed to a separation device, such as another classifier, for example a cyclone, for further separation. Each deflector wheel can be associated with a downstream separation device.

The gases and particles extracted from the impact reactor chamber with the classifier air can be separated from the classifier air in a subsequent process. The particles can be separated by means of a downstream classifier, for example a gravity classifier downstream of the deflector wheels. The separation of magnetic components by a magnetic classifier is also conceivable. It is also conceivable to guide the classifier air with particles through a screen arrangement or through filters. Separation of the gases, for example the solvents, can be achieved by gas separation, for example by a membrane method, a gas centrifuge or by distillation.

After separation of the particles and gases, the classifier air can be returned to the impact reactor chamber. In particular, it is conceivable to introduce the classifier air into the impact reactor chamber via openings made in the casing.

In particular, foils which can remain relatively large after comminution can also be removed via the ejection flap and subjected to downstream separation. However, it is also conceivable to extract foils via a deflector wheel. During the comminution process, foils are already released at the beginning of the comminution. In this respect, foils could be extracted via a slowly rotating deflector wheel. Chemical energy storages often feature both plastic foils and metal foils. Plastic foils remain relatively large during the comminution process and, due to their low density, can be discharged via the deflector wheel or removed together with the metal foils via a removal opening. It is advantageous that the metal foils can be pelletized by the impact process, which simplifies downstream material separation.

The casing, the bottom and/or the cover can be temperature controlled. For this purpose, it is conceivable to either heat or cool the casing, the bottom and/or the cover for temperature control. The temperature control can be effected by an externally mounted temperature control circuit. Heating can be advantageous if heat exposure enables better comminution. Cooling is particularly advantageous when comminution is accompanied by exothermic reactions.

The classifier can be temperature controlled. This makes it possible, for example, to heat the classifier and thus prevent condensation of gaseous components on the classifier. Alternatively, it is also conceivable to cool the classifier to prevent excessive heating when classifying hot media.

A first feed opening can be designed as an airlock. The airlock enables the feeding of material to be comminuted while maintaining an atmosphere in the impact reactor chamber that is independent of the environment.

The airlock can be designed as a rotary feeder. Rotary feeders are robust and allow targeted feeding of material to be comminuted into the impact reactor chamber. The rotary feeder can be equipped to either vacuum the volume in which the material to be comminuted is arranged and/or to flood it with nitrogen for inerting.

The rotary feeder can be arranged vertically. In this design, the feed of the material to be comminuted occurs around the circumference of the rotary feeder. Alternatively, the rotary feeder can also be arranged horizontally. In this design, the feed of the material to be comminuted takes place on the front side.

The airlock can include a pinch valve arrangement. A pinch valve arrangement comprises at least two arrangements of pinch valves so that a feed of material to be comminuted can be provided without exchanging ambient air with the impact reactor chamber. A pinch valve arrangement is particularly advantageous when the size of the material to be comminuted makes it unsuitable for a rotary feeder. It is also conceivable to provide three pinch valves, wherein the three pinch valves enclose two chambers, wherein a first chamber forms a safety blank chamber, and a second chamber is configured for vacuuming and/or for flooding with nitrogen.

The airlock can include at least one slide. Preferably, the airlock comprises two slides connected in series. Slides are particularly robust components and, depending on the design, it is possible to feed particularly large material to be comminuted. To prevent atmospheric exchange from occurring, the slides can be equipped with a sealing arrangement.

An advantageous sealing arrangement can be formed by an air bellows seal. This allows for a tight seal when the slide is closed, but can be relieved for opening the slide in such a way that the slide is released for opening. The slides can also be equipped with a cleaning device. The cleaning device can prevent particles and the like from getting into the mechanical linkage of the slides. Cleaning brushes can be provided for this purpose, for example, which act on the inside of at least one surface of the slides.

The airlock can comprise a roller arrangement. Preferably, at least two roller pairs are provided, spaced apart from each other. In the unloaded state, the rollers of the roller pairs rest against each other so that the feed opening is closed. For feeding material to be comminuted, the rollers of the roller pairs can be spaced apart so that material to be comminuted can be transported between the rollers of the roller pairs. In this case, the rollers abut against the material to be comminuted. This design is especially suitable for feeding particularly elongated material to be comminuted.

The casing, the bottom and/or the cover can be equipped with at least one fluid jet nozzle. The fluid jet nozzle allows a fluid jet, for example an air jet, to be introduced into the impact reactor chamber. The fluid jet causes local acceleration of already comminuted particles, which are further comminuted by collision with the fluid jet. The particles accelerated by the fluid jet bounce against the cylindrical casing, the floor or against the rotor. Furthermore, the particles to be comminuted bounce against other particles. Both cause further comminution of the material to be comminuted. The processed classifier air can be used for the fluid jet.

A further feed opening can be provided for the introduction of auxiliary materials. Through the further feed opening, an auxiliary material can be fed into the impact reactor chamber separately from the material to be comminuted.

The auxiliary material can be a gas, a liquid, and/or a particulate solid. For example, it is conceivable to introduce nitrogen or even flue gas via the additional feed opening to inert the impact reactor chamber. Furthermore, it is conceivable to introduce water into the impact reactor chamber, which cools the material to be comminuted and, depending on the embodiment, also improves comminution by reacting with the material to be comminuted. It is also conceivable to introduce sand or the like into the impact reactor chamber to improve the comminution result.

The impact reactor according to the invention is particularly suitable for comminuting accumulators which can still have a certain residual charge, and which are also not inactivated, for example by thermal pretreatment. By means of the rotor that is equipped with impact elements, only a very short contact with the material to be comminuted takes place. This can serve to prevent premature wear of the impact elements due to sparking, as is possible with cutting comminution equipment such as cutting mills.

Upstream of the feed opening, a device for pre-comminution can be provided. For example, a cutting mill in the form of a rotary shear can be associated with the feed opening. In this case, a closable feed opening can be associated with the device for pre-comminution in return, via which feed opening uncomminuted material, for example uncomminuted accumulators, are pre-comminuted. This makes it possible to subject accumulators of various sizes to pre-comminution so that material to be comminuted having a predetermined size can be fed to the impact reactor. The device is preferably directly associated with the feed opening, so that the transport distances are short. Furthermore, it is possible to arrange the device together with the feed opening in a housing so that noxious gases released during pre-comminution can be extracted in a targeted manner. The released gases can be fed via the feed opening into the impact reactor chamber and extracted from there.

In connection with pre-comminution, it is also conceivable to inactivate the accumulators to be comminuted in an upstream process, for example by thermal treatment.

Due to the closable removal opening and the closable feed opening, an inerting of the impact reactor chamber can be established so that chemical reactions occurring due to sudden discharge can be prevented. For this purpose, it is particularly advantageous to associate an airlock with the feed opening. Furthermore, any reaction gases that occur can be removed through the third removal opening described above. A vacuum can be created in the impact reactor chamber by extracting gas from the removal opening. It is also possible to flood the impact reactor chamber with an inerting gas, for example nitrogen or flue gas.

According to a method of accumulators in an impact reactor according to the invention as described before, accumulators are fed into the impact reactor chamber via the feed opening and comminuted by mechanical stress through the rotor provided with impact elements, wherein the comminuted components are removed through the removal opening.

The feed opening can be designed in such a way that the accumulators can be fed into the impact reactor chamber while the atmosphere is closed off. For this purpose, the feed opening can comprise an airlock, for example a rotary feeder. The airlock can further be equipped to be flooded with an inerting gas.

Auxiliary materials, for example inerting gases, can be introduced into the impact reactor chamber via a further feed opening, so that the impact reactor chamber can be flooded with an inerting gas such as nitrogen or flue gas.

The removal opening can be designed to evacuate the impact reactor chamber at least partially. This allows gaseous components released during the comminution process, for example solvents, to be removed from the impact reactor chamber.

Several removal openings can also be provided, wherein a first removal opening is designed for the removal of gaseous and powdery components and a second removal opening is designed for the removal of particulate and larger components.

A screen can be associated with the first removal opening and/or the second removal opening. The screen retains particles that cannot pass through the screen.

An ejection flap can be associated with the first removal opening and/or the second removal opening. The ejection flap allows the removal of comminuted components that cannot pass through the screen.

At least one removal opening can have a deflector wheel associated with it as described above.

The method according to the invention is particularly advantageous for comminuting accumulators that are not fully discharged and still have a residual charge. This includes accumulators, which can be fully charged. It is possible to put such accumulators with residual charge directly into the impact reactor and comminute them. In particular, it is not necessary to inactivate the accumulators beforehand, for example by thermal pretreatment. Contacting by the impact elements occurs always very briefly, so that the risk of voltage flashovers is reduced, which can lead to premature wear. Alternatively, the accumulators can be subjected to pre-comminution, which is particularly advantageous for voluminous accumulators.

The comminution process produces various comminution products, which can be separated from each other by the method and fed to a separate recycling process. Accumulators usually contain housings made of plastic or metal, foils made of plastic or metal, and electrolytes containing powdery components (black mass) and solvents.

The comminution of the accumulators can be done in such a way that first the housing of the accumulators is cut open and the cell winding is separated from the housing. This can be done with reduced power of the rotor and reduced speed of the rotor arms provided with the impact elements, so that the housing components are only opened and not or only slightly comminuted. In a next step, the housing components can first be removed before the electrode-separator arrangement that remains in the impact reactor, for example the cell winding, is further comminuted. This is particularly advantageous in the case of accumulators for small electrical appliances, which are embedded in a plastic housing.

Solvents can be released during the comminution of the cell winding. These can be extracted from the impact reactor chamber by applying negative pressure via a removal opening. A deflector wheel can be associated with the removal opening, which deflector wheel rotates at high speed to remove solvent and thus only allows gaseous components or at most particles with a very small particle size to pass through.

The black mass released during comminution, which comprises the powdery components of the electrolyte, can also be extracted from the impact reactor chamber via a removal opening. In doing so, a further material separation of the black mass can be made by an arrangement of several deflector wheels.

The remaining components of the battery, the foils and metallic components of the housing and the discharge plates can also be removed via a removal opening, either comminuted and passed through a screen or via the removal flap.

The method according to the invention is also suitable for the comminution of fuel cells.

Some embodiments of the impact reactor according to the invention are described in more detail below with reference to the figures. These show, each schematically:

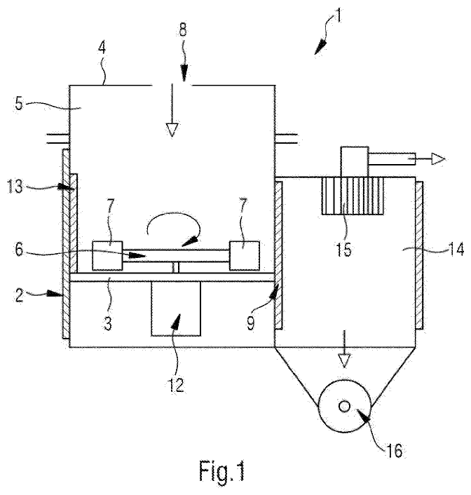

FIG. 1 an impact reactor with deflector wheel in the classifier behind the removal opening;

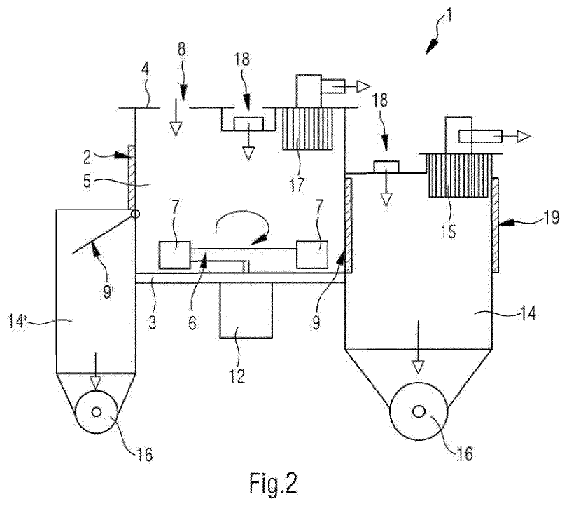

FIG. 2 an impact reactor with deflector wheel in the classifier behind the removal opening and a second deflector wheel in the cover;

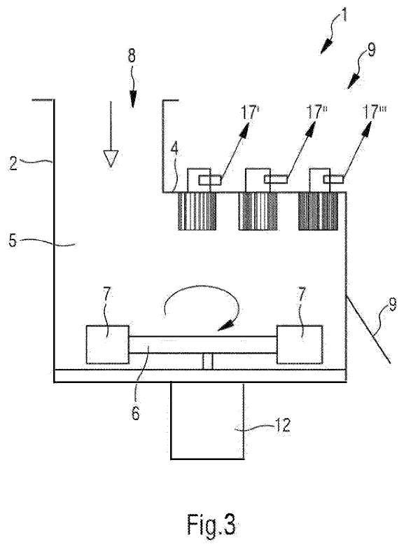

FIG. 3 an impact reactor with several deflector wheels in the cover;

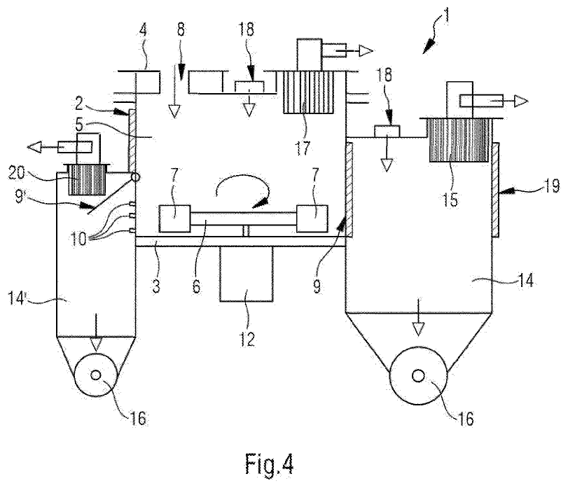

FIG. 4 an impact reactor with a deflector wheel in the ejection box;

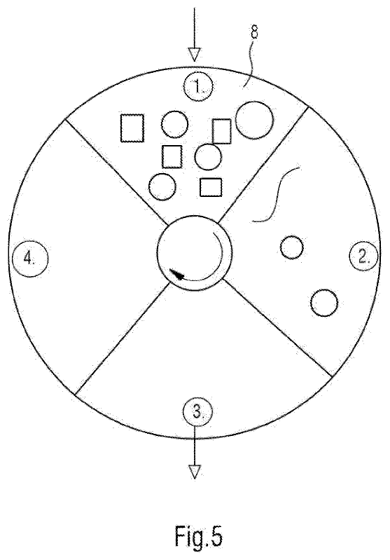

FIG. 5 a feed opening with rotary feeder;

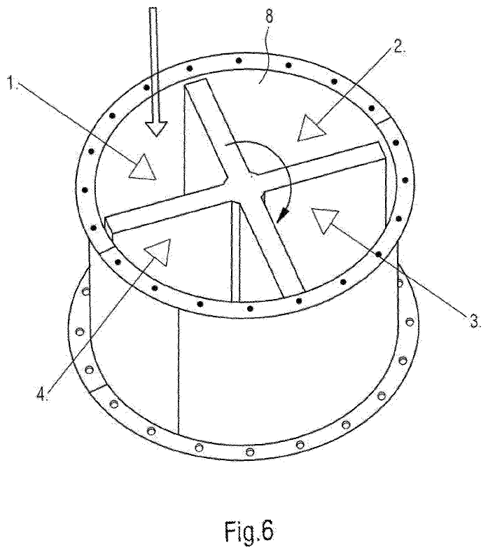

FIG. 6 a feed opening with rotary feeder;

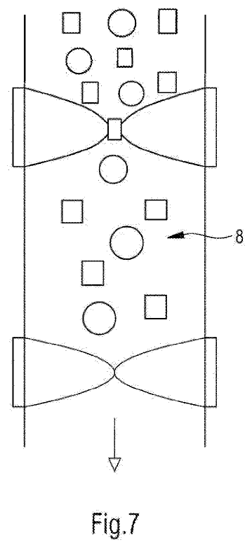

FIG. 7 a feed opening with pinch valve arrangement;

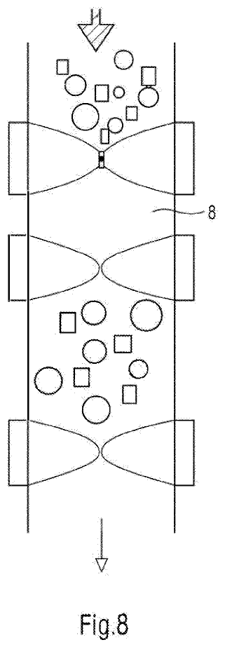

FIG. 8 a feed opening with pinch valve arrangement;

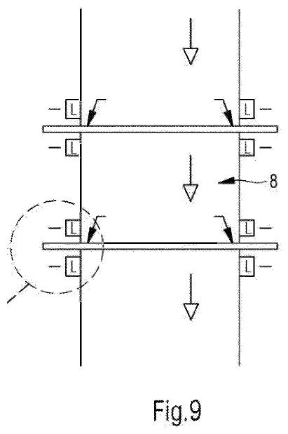

FIG. 9 a feed opening with slide;

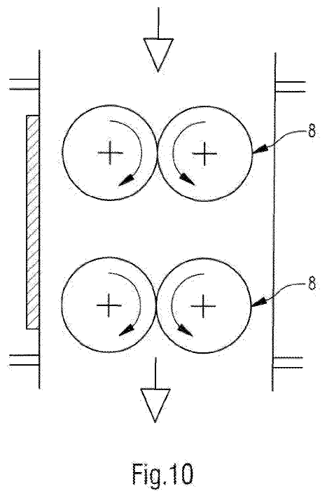

FIG. 10 a feed opening with roller arrangement.

FIG. 1 shows an impact reactor 1 for comminuting material to be comminuted, comprising a cylindrical casing 2, a bottom 3 and a cover 4, wherein the casing 2, the bottom 3 and the cover 4 enclose an impact reactor chamber 5, wherein a rotor 6 is arranged in the impact reactor chamber 5, wherein the rotor 6 is provided with impact elements 7, wherein at least one feed opening 8 is provided for feeding material to be comminuted into the impact reactor chamber 5, and wherein at least one removal opening 9 is provided for removing comminuted material and gaseous comminuted products from the impact reactor chamber 5, wherein the feed opening 8 and the removal opening 9 are closable. The rotor 6 is operatively connected to an electric motor 12 arranged outside the impact reactor chamber 5 via a shaft and can be set in rotation.

In the present embodiment, the removal takes place through a removal opening 9 made in the casing 2, wherein a screen is introduced into the removal opening 9. A classifier 14 in the form of a gravity classifier is connected downstream of the removal opening 9, wherein separation of gases and solids takes place. The gases are discharged via a deflector wheel 15 arranged in the cover of the classifier 14. Particles with a particle size of more than 0.5 μm are rejected by the deflector wheel and discharged via a discharge screw 16 arranged at the bottom of the classifier 14.

The casing 2 of the impact reactor 1 is hexagonal when viewed from above. Alternatively, the casing 2 can also be octagonal when viewed from above. With the rotor 6 rotating, a turbulent flow field is formed in the impact reactor chamber 5 in this embodiment, which supports the comminution process and a pelletizing process of flat metal pieces. To further improve the flow field, devices 13 projecting into the impact reactor chamber 5 are attached to the casing 2.

The casing 2 of the impact reactor 1 can be temperature controlled. For this purpose, a pipe arrangement is attached to the exterior of the casing 2. A heat transfer medium can be fed through the pipeline, which optionally heats or cools the casing 2. Alternatively, it is conceivable that an electric resistance heater is attached to the exterior of the casing 2.

The feed opening 8 is designed in the form of an airlock. This makes it possible to shield the impact reactor chamber 5 from the surroundings and it can be prevented that gases released during the comminution reach the surroundings via the feed opening 8. Furthermore, it is possible to flood the impact reactor chamber 5 with an inert gas.

The impact reactor 1 is further provided with a further removal opening, which is used in particular for the removal of coarsely comminuted solids and foils.

The impact reactor 1 is configured to comminute chemical energy stores, in particular electrochemical energy stores in the form of accumulators, for example lithium-ion accumulators, and to provide comminuted material. The comminution products resulting from the comminution, in particular gases and powders, can then be supplied to material recycling.

In the method for comminution of chemical energy storage cells in the impact reactor 1, chemical energy stores are fed to a pre-comminution in a first step. Pre-comminution can be performed by means of a rotor shear, which separates the chemical energy stores. In doing so, the rotor shear is directly associated with the feed opening 8 and is arranged in a housing together with the feed opening 8.

In particular, the chemical energy stores can be inerted by means of vacuum distillation prior to pre-comminution.

In a second step, the pre-comminuted energy stores are fed to the impact reactor 1 via the feed opening 8 and comminuted under the influence of the rotor 6 provided with the impact elements 7. In a third step, the comminution products are removed via the removal opening 9, wherein the removal is carried out separately for gases, particles and residual components.

FIG. 2 shows a further development of the impact reactor 1 described in FIG. 1. In addition, a deflector wheel 17 is arranged in the cover 4 of the impact reactor 1. Gas is extracted from the impact reactor chamber 5 via said deflector wheel 17, which forms a removal opening 9, and a negative pressure is produced in the impact reactor chamber 5. In particular, reactive gas, which is released during the comminution of chemical energy stores, is extracted from the impact reactor chamber 5 via the deflector wheel 17. A further removal opening 9′ is provided in the casing 2, wherein a further classifier 14′ adjoins the further removal opening 9′.

Auxiliary materials for comminution, for example liquid, gas or powder, can be introduced into both the impact reactor chamber 5 and the classifier 14 downstream of the removal openings 9 via openings 18 made in the covers 4. The classifier casing 19 as well as the casing 2 can be temperature controlled.

FIG. 3 shows another alternative embodiment of the impact reactor 1 described in FIG. 1. In the present embodiment, three deflector wheels 17′, 17″, 17′″ are provided in the cover 4 of the impact reactor 1, which form removal openings 9.

The first deflector wheel 17′ only allows gaseous components and particles with a particle size of less than 0.5 μm to pass through. The second deflector wheel 17″ allows particles with a particle size of 0.5 μm to 200 μm to pass through, and the third deflector wheel 17′″ allows particles suspended in the impact reactor chamber 5 from 200 μm onwards to pass through. Thus, separation of gases and substances of different sizes can be performed by the arrangement of deflector wheels 17′, 17″, 17′″.

During comminution, separation first takes place via the first deflector wheel 17′, which allows gaseous constituents to pass through. This deflector wheel 17′ rotates at a particularly high speed. In the next step, separation takes place via the second deflector wheel 17″ to allow particles of a medium grain size to pass through. Finally, the air is passed through the third deflector wheel 17′″, which separates particles in the air stream with a particle size above 200 μm. In this respect, the deflector wheels 17′, 17″, 17′″ can let particles through one after the other, but the letting through can also take place simultaneously.

According to an alternative embodiment, a deflector wheel 17 is associated with the cover 4, the speed of which can be varied in three speed levels. In a first speed level at high speed, gaseous components and particles with a particle size of less than 0.5 μm are first allowed to pass through. In a second speed level with reduced speed, particles with a medium particle size of 0.5 μm to 200 μm are allowed to pass through. In a third speed level with further reduced speed, particles with a particle size of more than 200 μm up to a particle size of 500 μm are allowed to pass through.

Larger comminution products can be removed via a removal opening 9 in the form of a removal flap provided in the casing 2. A classifier 14 as shown in FIG. 1 or FIG. 2 can be connected to this removal opening.

FIG. 4 shows a further development of the impact reactor 1 described in FIG. 2. In addition, a classifier 14′ in the form of a gravity classifier is connected downstream of the second removal opening 9′, wherein separation of gases and solids takes place. The gases are extracted via a deflector wheel 20 arranged in the cover of the classifier 14′. Particles with a particle size of more than 0.5 μm are rejected by the deflector wheel 20.

Fluid jet nozzles 10 are introduced into the casing of the impact reactor, via which a fluid jet can be introduced into the impact reactor chamber 5. The fluid jet supports the comminution process.

FIGS. 5 and 6 show in detail a feed opening 8 in the form of a rotary feeder of an impact reactor 1 according to one of the previously described embodiments.

FIGS. 7 and 8 show in detail a feed opening in the form of a pinch valve arrangement of an impact reactor 1 according to one of the previously described embodiments.

FIG. 9 shows in detail a feed opening in the form of a slide of an impact reactor 1 according to one of the embodiments described above.

FIG. 10 shows in detail a feed opening in the form of a roller arrangement of an impact reactor 1 according to one of the embodiments described above.

What is claimed is:

1. An impact reactor for comminuting material to be comminuted, comprising a cylindrical casing, a bottom and a cover, wherein the casing, the bottom and the cover enclose an impact reactor chamber, wherein a rotor is arranged in the impact reactor chamber, wherein the rotor (6) is provided with impact elements, wherein at least one feed opening is provided for feeding material to be comminuted into the impact reactor chamber, and wherein at least one removal opening is provided for removing comminuted material and/or gaseous comminuted products from the impact reactor chamber, wherein the feed opening and/or the removal opening are closable.

2. The impact reactor according to claim 1, wherein a classifier is associated with the at least one removal opening.

3. The impact reactor according to claim 1, wherein a suction device is associated with the at least one removal opening.

4. The impact reactor according to claim 1, wherein a deflector wheel is associated with at least one removal opening.

5. The impact reactor according to claim 1, wherein several removal openings are provided, wherein a deflector wheel is associated with each of the removal openings.

6. The impact reactor according to claim 1, wherein a screen and a removal flap are associated with at least one removal opening.

7. The impact reactor according to claim 1, wherein a screen, a classifier and/or a deflector wheel is associated with at least one removal opening.

8. The impact reactor according to claim 1, wherein a first feed opening is designed as an airlock.

9. The impact reactor according to claim 8, wherein the airlock is designed as a rotary feeder.

10. The impact reactor according to claim 8, wherein the airlock comprises a pinch valve assembly.

11. The impact reactor according to claim 8, wherein the airlock comprises at least one slide.

12. The impact reactor according to claim 8, wherein the airlock comprises a roller assembly.

13. The impact reactor according to claim 1, wherein at least one fluid jet nozzle is provided, via which a fluid jet can be introduced into the impact reactor chamber.

14. The impact reactor according to claim 13, wherein the at least one fluid jet nozzle is associated with the casing.

15. The impact reactor according to claim 1, wherein gas removed from the impact reactor chamber via the at least one removal opening can be fed back to the impact reactor chamber.

16. The impact reactor according to claim 1, wherein a further feed opening is provided for the introduction of auxiliary substances.

17. The impact reactor according to claim 1, wherein at least the casing is temperature-controllable.

18. A method for comminution of chemical energy storage cells in an impact reactor according to claim 1, in which in a first step chemical energy storages are fed to a pre-comminution, in a second step the pre-comminuted energy storage cells are fed to the impact reactor via a feed opening and comminuted under the influence of the rotor provided with the impact elements, in a third step the comminution products are removed via the removal openings, wherein the removal is carried out separately for gases, particles and residual constituents.
